(19) United States
(12) Patent Application Publication
(10) Pub. No.: US 2025/0061665 A1
(43) Pub. Date: Feb. 20, 2025

(54) IMAGE DISPLAY METHOD, ELECTRONIC DEVICE AND STORAGE MEDIUM

(71) Applicant: Beijing Bytedance Network Technology Co., Ltd., Beijing (CN)

(72) Inventor: Shaohui JIAO, Beijing (CN)

(21) Appl. No.: 18/725,344

(22) PCT Filed: Apr. 18, 2023
(86) PCT No.: PCT/CN2023/089010

§ 371 Date: Jun. 28, 2024

(30) Foreign Application Priority Data
May 24, 2022 (CN) 202210575768.6

(51) Int. Cl. G06T 19/00; G06T 5/50; G06V 10/56; H04N 9/73

(52) U.S. Cl. CPC G06T 19/006; G06T 5/50; G06V 10/56; H04N 9/73; G06T 2207/10024; G06T 2207/20221

(57) ABSTRACT

Embodiments of the present disclosure provided an image display method, apparatus, electronic device and storage medium. The method includes: acquiring a converted image corresponding to each video frame in a target video; acquiring a background pose of a background capturing device at a target moment, and determining a perspective image corresponding to the background pose from at least one converted image corresponding to the target moment; converting a pixel point in the perspective image into a background capturing coordinate system where the background capturing device is located according to the background pose to obtain a target image; combining a background image captured by the background capturing device at the target moment with the target image to obtain an augmented reality image, and displaying the augmented reality image.

The present application claims priority of Chinese Patent Application No. 202210575768.6, filed on May 24, 2022, the entire contents of the above application are incorporated into this application by reference.

### TECHNICAL FIELD

Embodiments of the present disclosure relate to the technical field of data processing, for example, to an image displaying method, an apparatus, an electronic a device and a storage medium.

### BACKGROUND

Free perspective video is a popular form of video nowadays, which provides users with the function of interactive selection of viewing angles, giving them a fixed two-dimensional (2D) video viewing experience of “walk-over”, thus bringing strong stereoscopic impact to users.

Currently, free perspective videos are primarily presented by building a separate interactive player, which can be presented to the user by way of a slider bar so that the user views the video at different perspectives by dragging the slider bar. However, this approach results in a poor experience due to limited freedom of viewing by the user.

### SUMMARY

Embodiments of the present disclosure provide an image display method, an apparatus, an electronic device and a storage medium.

In a first aspect, embodiments of the present disclosure provide an image display method, which may include:

Acquiring a converted image respectively corresponding to each video frame in a target video, wherein the converted image is an image obtained after converting a pixel point located in an image coordinate system in a foreground image into an augmented reality coordinate system, the foreground image is an image comprising a foreground object and extracted from the video frame, and the target video comprises a free perspective video or a light field video;

Acquiring a background pose of a background capturing device at a target moment, and determining a perspective image corresponding to the background pose from at least one converted image corresponding to the target moment;

Converting a pixel point in the perspective image into a background capturing coordinate system where the background capturing device is located according to the background pose to obtain a target image; and

Combining a background image captured by the background capturing device at the target moment with the target image, and displaying an augmented reality image obtained by the combining.

In a second aspect, an embodiment of the present disclosure further provides an image display apparatus, which may include:
A converted image acquisition module, configured to acquire a converted image respectively corresponding to each video frame in a target video, wherein the converted image is an image obtained after converting a pixel point located in an image coordinate system in a foreground image into an augmented reality coordinate system, the foreground image is an image comprising a foreground object and extracted from the video frame, and the target video comprises a free perspective video or a light field video;
A perspective image determination module, configured to acquire a background pose of a background capturing device at a target moment, and determine a perspective image corresponding to the background pose from at least one converted image corresponding to the target moment;
A target image obtaining module, configured to convert a pixel point in the perspective image into a background capturing coordinate system where the background capturing device is located according to the background pose to obtain a target image; and
An augmented reality image display module, configured to combine a background image captured by the background capturing device at the target moment with the target image, and display an augmented reality image obtained by the combining.

In a third aspect, an embodiment of the present disclosure further provides an electronic device, may include:
One or more processors;
A memory, which is configured to store one or more programs,
When the one or more programs are executed by the one or more processors, cause the one or more processors to implement the image display method provided by any embodiment of the present disclosure.

In a fourth aspect, an embodiment of the present disclosure further provides a computer-readable storage medium, on which computer programs are stored, when the computer programs are executed by a processor, the image display method provided by any embodiment of the present disclosure.

### BRIEF DESCRIPTION OF DRAWINGS

Throughout the drawings, the same or similar reference numerals refer to the same or similar elements. It should be understood that the drawings are schematic and that components and elements are not necessarily drawn to scale.

FIG. 1 is a flowchart of an image display method in embodiments of the present disclosure;

FIG. 2 is a flowchart of another image display method in embodiments of the present disclosure;

FIG. 3 is a flowchart of another image display method in embodiments of the present disclosure;

FIG. 4 is a schematic diagram of one type of example of another image display method in embodiments of the present disclosure;

FIG. 5 is a structural schematic diagram of an image display method in embodiments of the present disclosure; and

FIG. 6 is a structural schematic diagram of an electronic device in embodiments of the present disclosure.

### DETAILED DESCRIPTION

Embodiments of the present disclosure will be described below with reference to the accompanying drawings. While certain embodiments of the present disclosure are illustrated in the accompanying drawings, it is to be understood that the present disclosure may be embodied in various forms and should not be construed as limited to the embodiments set forth herein, but rather, these embodiments are provided for a more thorough and complete understanding of the present disclosure. It should be understood that the drawings and embodiments of the present disclosure are for illustrative purposes only and are not intended to limit the scope of the present disclosure.

It should be understood that the various steps recited in the method implementation of the present disclosure may be performed in a different order, and/or in parallel. Further, the method implementation may include additional steps and/or omit performing illustrated steps. The scope of the present disclosure is not limited in this regard.

As used herein, the term “include” and its variations are open inclusion, that is, means “including, but not limited to”. The term “based on” is “based at least in part on.” The term “one embodiment” means “at least one embodiment”; the term “another embodiment” means “at least one additional embodiment”; the term “some embodiments” means “at least some embodiments”. Relevant definitions for other terms will be given in the description below.

It should be noted that the concepts such as “first”, “second” and the like mentioned in the present disclosure are only used to distinguish different apparatuses, modules or units, and are not used to limit the sequence or interdependence of the functions performed by these apparatuses, modules or units.

It is noted that the modifications referred to as “a” or “a plurality” in this disclosure are illustrative rather than limiting, and those skilled in the art should understand that it should be understood as “one or more” unless the context clearly indicates otherwise.

The names of messages or information exchanged between multiple apparatuses in the embodiments of the present disclosure are for an illustrative purpose only and are not used to limit the scope of these messages or information.

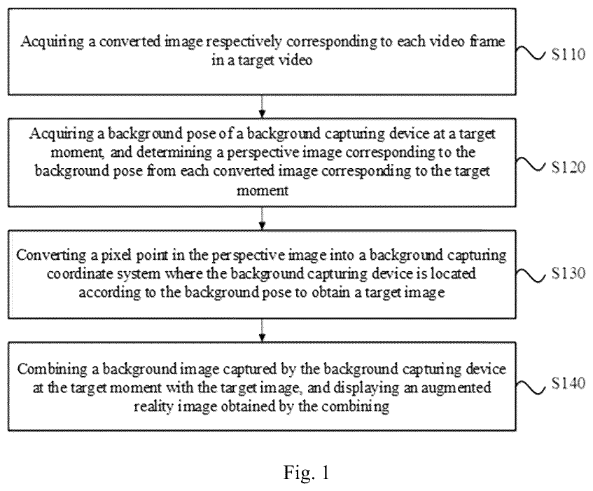

FIG. 1 is a flowchart of an image display method provided in embodiments of the present disclosure. The present embodiments can display video frames in a target video in an Augmented Reality (AR) manner, thereby achieving AR displaying of the target video. The method may be performed by the image display apparatus provided by embodiments of the present disclosure, the apparatus may be implemented by means of software and/or hardware, the apparatus may be integrated on an electronic device, which may be various terminal devices (like a cell phone, a tablet computer or a head-mounted display device, etc.) or a server.

Referring to FIG. 1, the method of embodiments of the present disclosure includes the following steps:

S110, acquiring a converted image respectively corresponding to each video frame in a target video, the converted image is an image obtained after converting a pixel point located in an image coordinate system in a foreground image into an augmented reality coordinate system, the foreground image is an image comprising a foreground object and extracted from the video frame, and the target video includes a free perspective video or a light field video.

The target video may be a video having a plurality of perspectives, for example, a free perspective video or a light-field video, the free perspective video may be a video in which a plurality of foreground capturing devices are disposed in a circular ring around a subject to be captured (i.e., a foreground subject) so as to synchronously capture the foreground subject; the light-field video may be a video obtained by simultaneously capturing light-field samples from different viewpoints, i.e., perspectives, within a target space in which foreground objects are disposed by a plurality of foreground capturing devices distributed on a plane or spherical surface. Note that the foreground capturing device may be a camera (e.g., a light field camera or a general camera), a video camera, a camera, or the like; the processes of obtaining the free perspective video and the light-field video described above are only examples, and they can be derived on the basis of other ways, which are not specifically limited here.

The video frame may be a piece of video images in the target video from which, for each video frame, a foreground image including a foreground object, which may be a subject object and/or a hand-held object of the subject object in the target video, etc., is extracted (i.e. picked). Each video frame corresponds to its own converted image, the converted image can be understood as an image obtained by converting the pixel point located in the image coordinate system in a foreground image into an augmented reality coordinate system, the image coordinate system can be understood as the spatial coordinate system in which the foreground image locates, and the AR coordinate system can be understood as the screen coordinate system of the image display device used to display the subsequent generated AR image. It is to be noted that the sense of setting image converting is that, taking the example that the foreground capturing device is a camera, in order to achieve AR display of the video frame, the multi-camera acquisition point at the time of capturing the video frame cannot be matched with the virtual camera position point at the time of AR display, so that projection transformation is required here, and a new perspective image (i.e., transition image) at the virtual camera position point is generated, so that it can be matched with AR display to obtain a correct perspective image (i.e., image that needs to be correctly displayed) in the case of camera transformation. In addition, the image display apparatus may directly acquire and apply the converted image which is processed in advance, may separately process each directly acquired video frame and then apply the converted image, or the like, which is not specifically limited herein.

S120, acquiring a background pose of a background capturing device at a target moment, and determining a perspective image corresponding to the background pose from each converted image corresponding to the target moment.

The background capturing device may be a device different from the foreground capturing device for capturing the background object in the AR image, and the background pose may be the pose of the background capturing device at the target moment, which may be represented, for example, by device position and device orientation, 6 degrees of freedom; the target time may be a historical time, a current time, a future time, or the like, which is not specifically limited here. For video frames corresponding to AR images presented at the target moment, each converted image corresponding to the target moment may be understood as converted images corresponding to those video frames captured synchronously with that video frame. For example, assuming that the video frame corresponding to the AR image presented at the present time is the 50th video frame of the target video, each of the converted images corresponding to the target time may be the converted images corresponding to the 50th video frames captured synchronously. Capturing perspectives of the respective converted images corresponding to the target moment are different from each other, a background perspective corresponding to a background pose is determined from respective capturing perspectives, the background perspective can be understood as a viewing perspective of the user at the target moment, and then a converted image having the viewing perspective among the converted images is taken as a perspective image, so that an AR image generated and presented based on the perspective image is an image matching the viewing perspective.

S130, converting a pixel point in the perspective image into a background capturing coordinate system where the background capturing device is located according to the background pose to obtain a target image.

The background capturing coordinate system can be a space coordinate system where the background capturing device is located, it needs to be explained that the AR coordinate system and the background capturing coordinate system are different space coordinate systems, for example the AR coordinate system can be a screen coordinate system of the cellphone, and the background capturing coordinate system can be a space coordinate system where the camera inside the cellphone is located; as another example, the AR coordinate system may be a screen coordinate system of the head-mounted display device, the background photographing coordinate system may be a spatial coordinate system where the camera within the flat panel is located; and the like, and are not specifically limited herein.

The perspective image located in the AR coordinate system is converted into the background capturing coordinate system according to the background pose, and the target image is obtained. In practical applications, for example, in order to obtain a target image that more closely matches the background image, in addition to the background pose, the background intrinsic parameters of the background capturing device may be considered, which may reflect the focal length and distortion of the background capturing device. On this basis, by way of example, suppose that the pixel point in the target image is represented by P_{t-cam}, then P_{t-cam}=K_{cam} [R_{cam}|t_{cam}]P_{AR}, where, P_{AR} denotes the pixel point in the perspective image. K_{cam} denotes the background reference. R_{cam} denotes the rotation matrix of the background capturing device, and team denotes the translation matrix of the background capturing device, where the background pose is represented by R_{cam} and t_{cam}.

S140, combining a background image captured by the background capturing device at the target moment with the target image, and displaying an augmented reality obtained by the combining.

The background image may be an image captured by the background capturing device at the target time, the background image and the target image are combined, the combining manner may be fusion or superimposition, etc., and then the AR image obtained after the combining is displayed, thereby achieving the effect of AR display of the video frame. Then, the effect of AR display of the target video is thus achieved when the respective AR images are sequentially displayed in the order of sequential acquisition of the respective video frames in the target video. Thus, the user can view the video at the corresponding perspective in the target video by moving the spatial position of the background capturing device in an interactive manner, thereby ensuring the degree of freedom of the user in viewing the target video, and realizing the user viewing process of the target video with six degrees of freedom. In addition, the above-described embodiment realizes the display process of the target video by putting the target video into the AR domain to be played, not by rendering the three-dimensional model, whereby it is possible to present a fine feeling that cannot be exhibited plana by the three-dimensional model, such as a clear display of the hair strand of a person, and the user experience is better.

Embodiments of the present disclosure, by acquiring a converted image respectively corresponding to each video frame in a target video, the converted image may be an image after converting a pixel point located in an image coordinate system in a foreground image extracted from the video frame into an AR coordinate system; acquiring a background pose of the background capturing device at the target moment, and determining a perspective image corresponding to the background pose from each of the converted images corresponding to the target moment; converting a pixel point in the perspective image into a background capturing coordinate system where the background capturing device is located according to the background pose, obtaining a target image; thus, the background image captured by the background capturing device at the target time is combined with the target image, and the combined AR image is displayed. The above embodiment, can display the video frame in the target video based on the AR manner. i.e., the target video is played based on the AR manner, which achieves the interactive viewing process of the target video through the AR manner, thereby guaranteeing the degree of freedom in watching the target video by the user, and the user experience is better.

In an embodiment, based on the above embodiment, the determining a perspective image corresponding to the background pose from the converted image corresponding to the target moment may include: taking the video frame corresponding to the augmented reality image displayed at a previous moment of the target moment as a previous frame, and determining a next frame of the previous frame from at least one video frame; taking the converted image respectively corresponding to each next frame as the converted image corresponding to the target moment, respectively acquiring a capturing perspective of the converted image corresponding to the target moment; determining a background perspective corresponding to the background pose from the capturing perspective, and taking the converted image having the background perspective from at least one converted image corresponding to the target moment as a perspective image. Therein, the previous frame may be one of the video frames corresponding to the AR image displayed at the previous moment of the target moment. i.e. the video frame corresponding to the target image involved at the time of combining to obtain the AR. The next frame may be a video frame among the video frames that can be played after the previous frame is played, and since the target video is a video having a plurality of perspectives, there are a plurality of synchronously captured next frames. The respective converted images respectively corresponding to the respective next frames are taken as the respective converted images corresponding to the target moments, and a capturing perspective of each converted image is respectively acquired, which can show at what perspective of view the foreground capturing device used for capturing the video frame corresponding to the converted image is captured. Thus, it is possible to determine a background perspective corresponding to the background pose, which can reflect a viewing perspective of the user at the target moment, then, the converted images corresponding to the target time with the background perspective are used as the perspective images, and the AR images generated and displayed based on the perspective images are images that match the background perspective.

In another embodiment, based on the above embodiment, combining a background image captured by the background capturing device at the target moment with the target image, and displaying a combined augmented reality image may include: acquiring a background image captured by the background capturing device at the target moment, identifying a background plane in the background image, and obtaining a plane position of the background plane in the background image; combining the background image with the target image based on the plane position so that the foreground object in the combined augmented reality image lies on the background plane; displaying the augmented reality image. Wherein, the background plane may be a plane in the background image for overlooking the foreground object, i.e., a plane captured by the background capturing device; the plane position may be the position of the background plane in the background image. And combining the background image with the target image based on the plane position so that the foreground object in the obtained AR image lies on the background plane, such as a dancing girl standing on a desk surface to dance, thereby increasing the interest of the AR image.

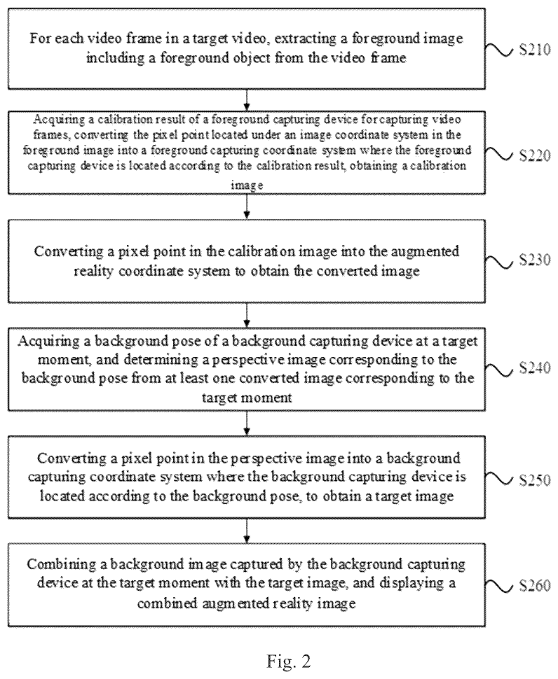

FIG. 2 is a flowchart of another image display method provided in embodiments of the present disclosure. The present embodiment is adapted on the basis of the above-described embodiments. In this embodiment, the above image display method may further include extracting, for each of the video frames, the foreground image from the video frame; acquiring a calibration result of a foreground capturing device used to capture the video frame; converting the pixel point located in an image coordinate system in the foreground image into a foreground capturing coordinate system where the foreground capturing device is located according to the calibration result, obtaining a calibration image; converting a pixel point in the calibration image into the augmented reality coordinate system, obtaining the converted image. Therein, explanations of terms identical or corresponding to the above-described embodiments are not repeated herein.

Correspondingly, as shown in FIG. 2, the method of this embodiment may include the following steps:

S210, for each video frame in a target video, extracting a foreground image including a foreground object from the video frame, wherein the target video includes a free perspective video or a light field video.

Assuming that the target video is captured by N foreground capturing devices and each foreground capturing device synchronously captures M frames of video, N and M are positive integers, each of the M*N frames of video frames may be processed separately based on S210-S230. For example, for each video frame, a foreground image is extracted therefrom, which may be understood as an image matting process, which may be implemented in a variety of ways, such as binary classification, portrait matting, background prior-based matting, or green matting of the video frame, etc., resulting in a foreground image.

S220, acquiring a calibration result of a foreground capturing device for capturing video frames, converting the pixel point located in an image coordinate system in the foreground image into a foreground capturing coordinate system where the foreground capturing device is located according to the calibration result to obtain a calibration image.

The calibration results may be the results obtained after calibration of the foreground capturing device, which in practice may be represented by foreground poses and foreground intrinsic parameter. Exemplarily, in order to shorten calibration time and reduce calibration difficulty, calibration may be performed in the following manner; acquiring video frame sequences captured by each foreground capturing device respectively, and determining feature matching relationships between these video frame sequences; the calibration results for each foreground capturing device are respectively obtained based on the feature matching relationship. Since the calibration process described above is a self-calibration process, it can be carried out by taking a sequence of video frames without involving a calibration plate, thereby achieving the effect of shortening the calibration time and reducing the difficulty of calibration. The above example is only one method of the calibration result obtaining process, and the calibration result may be obtained based on the remaining means, and is not specifically limited here.

The foreground capturing coordinate system may be a coordinate system where the foreground capturing device is located, and each pixel point in the foreground image is converted into the foreground capturing coordinate system according to the calibration result, and the calibration image is obtained. Illustratively, suppose that a pixel point in the anchor image is denoted by P, then P=[R|t]⁻¹K⁻¹pₜ, where pₜ denotes a pixel point in the foreground image, R denotes a rotation matrix of the foreground capturing device, t denotes a translation matrix of the foreground capturing device, where the foreground pose is denoted by R and t, K denotes a foreground intrinsic parameter.

S230, converting a pixel point in the calibration image into the augmented reality coordinate system to obtain the converted image.

Wherein if each foreground capturing device has been subjected to an alignment process before capturing the target video, which means that each foreground capturing coordinate system is the same spatial coordinate system, the pixel points in the calibration image can be directly converted into the AR coordinate system to obtain a converted image; otherwise, the alignment process can be performed on each foreground capturing coordinate system, and then the pixel points in the calibration image can be converted; and the like.

S240, acquiring a background pose of a background capturing device at a target moment, and determining a perspective image corresponding to the background pose from at least one converted image corresponding to the target moment.

S250, converting a pixel point in the perspective image into a background capturing coordinate system where the background capturing device is located according to the background pose to obtain a target image.

S260, combining a background image captured by the background capturing device at the target moment with the target image, and displaying a combined augmented reality image.

Embodiments of the present disclosure, by extracting a foreground image from a video frame, and then converting pixel points in the foreground image into a foreground capturing coordinate system according to a calibration result of a foreground capturing device used to capture the video frame, respectively, and then converting the thus obtained calibration image into an AR coordinate system for each video frame, achieve accurate obtaining of a converted image.

In one embodiment, on the basis of the above embodiment, converting a pixel point in the calibration image into the augmented reality coordinate system, obtaining the converted image includes: acquiring a fixed-axis coordinate system, wherein the fixed-axis coordinate system is a coordinate system determined according to a foreground pose of foreground capturing device or the video frame captured; converting the pixel point in the calibration image into the fixed-axis coordinate system, obtaining a fixed-axis image; converting a pixel point in the fixed-axis image into the augmented reality coordinate system, obtaining the converted image.

Among them, when a plurality of foreground capturing devices are set up manually, they are usually expected to be set up on the same plane, but this requirement is difficult to achieve by manual alignment, which is time-consuming and labor-intensive, and accuracy is difficult to guarantee. However, the object video captured by each foreground capturing device that is not aligned has a jitter phenomenon when the perspective changes, which directly affects the user's viewing experience of the object video. In order to avoid this, it is possible to acquire a fixed-axis coordinate system for realizing the fixed-axis function, and then convert the calibration image into the fixed-axis coordinate system, thereby obtaining a fixed-axis image which does not exhibit a jitter phenomenon at the time of the perspective change. In practice, for example, the fixed-axis coordinate system can be obtained in various ways, such as based on the foreground poses of each foreground capturing apparatus, for example, the fixed-axis coordinate system can be obtained by calculating a corresponding homography matrix based on each foreground pose; for example, based on the video frames captured by various foreground capturing devices, feature matching is performed on these video frames to obtain a fixed-axis coordinate system; and the like, and are not specifically limited herein. Further, the fixed-axis image is converted into an AR coordinate system to obtain a converted image, so as to avoid the occurrence of jitter of the converted image in the perspective change.

On this basis, in one embodiment, converting the pixel point in the calibration image into the fixed-axis coordinate system, obtaining a fixed-axis image may include: acquiring a first homography matrix from the foreground capturing coordinate system to the fixed-axis coordinate system, and converting the pixel point in the calibration image into the fixed-axis coordinate system based on the first homography matrix, obtaining a fixed-axis image. Exemplarily, assuming that the pixel points in the fixed-axis image are represented by P_{fix-axis}, then P_{fix-axis}=H_{F}P, where, P represents the pixel points in the fixed-axis image, and H_{F} represents the first homography matrix.

In another embodiment, converting a pixel point in the fixed-axis image into the augmented reality coordinate system, obtaining the converted image, may include: acquiring a second homography matrix from the fixed-axis coordinate system to the augmented reality coordinate system, and converting a pixel point in the fixed-axis image into the augmented reality coordinate system based on the second homography matrix, obtaining in the converted image. Exemplarily, suppose that the pixel points in the converted image are denoted by P_{AR}, then P_{AR}=H_{A}P_{fix-axis}, where P_{fix-axis} denotes the pixel points in the fixed-axis image and H_{A} denotes the second homography matrix.

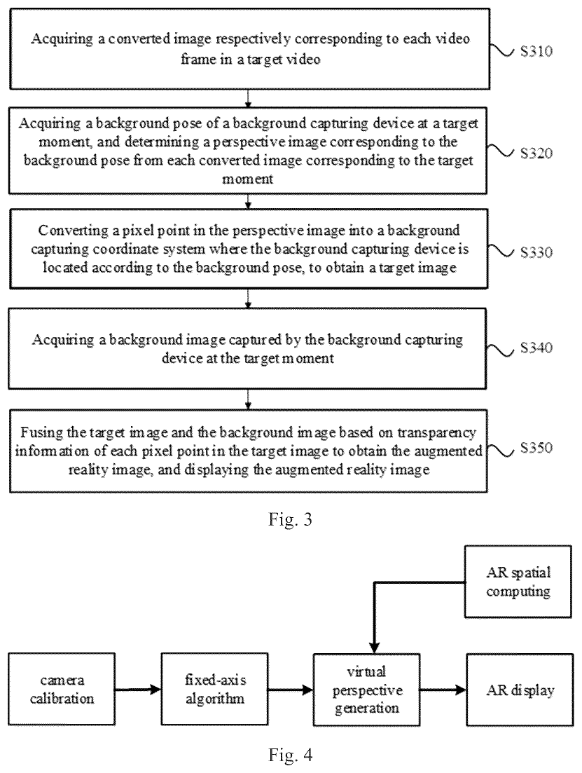

FIG. 3 is a flowchart of another image display method provided in embodiments of the present disclosure. The present embodiment is adapted on the basis of the above-described embodiments. In this embodiment, combining a background image captured by the background capturing device at the target moment with the target image, and displaying a combined augmented reality image may include: acquiring a background image captured by the background capturing device at the target moment; fusing the target image and the background image to obtain an augmented reality image based on transparency information of a pixel point in the target image, and displaying the augmented reality image. Therein, explanations of terms identical or corresponding to the above-described embodiments are not repeated herein.

Correspondingly, as shown in FIG. 3, the method of this embodiment may include the following steps:

S310, acquiring a converted image respectively corresponding to each video frame in a target video, wherein the converted image is an image obtained after converting a pixel point located under an image coordinate system in a foreground image into an augmented reality coordinate system, the foreground image is an image including a foreground object extracted from the video frame, and the target video includes a free perspective video or a light field video.

S320, acquiring a background pose of a background capturing device at a target moment, and determining a perspective image corresponding to the background pose from each converted image corresponding to the target moment;

S330, converting a pixel point in the perspective image into a background capturing coordinate system where the background capturing device is located according to the background pose to obtain a target image.

S340, acquiring a background image captured by the background capturing device at the target moment.

S350, fusing the target image and the background image based on transparency information of each pixel point in the target image to obtain the augmented reality image, and displaying the augmented reality image.

Wherein, for each pixel point in the target image, its transparency information can represent information of the pixel point in a transparency channel (i.e., alpha channel), fusion of the target image and the background image can be achieved based on the transparency information of the respective pixel points, to obtain an AR image. Exemplarily, for any pixel point foreground in the target image, whose transparency information is represented based on the alpha, then the pixel point after fusing the pixel point with the corresponding pixel point background in the background image can be expressed as: Pixel_final=alpha*foreground+(1−alpha)*background, where Pixel_final represents the fused pixel point. It should be noted that, as described above, the embodiment of the present disclosure realizes the display process of the target video by putting the target video into the AR field for playing, not by rendering the three-dimensional model in real time through lighting, in other words, the target video cannot be rendered again, which is the video data itself, so that the AR image is obtained by fusion.

The embodiment of the present disclosure, the fusion of the target image and the background image is achieved through the transparency information of each pixel point in the target image, thereby guaranteeing the effective resulting effect of the AR image.

In one embodiment, on the basis of the above embodiments, before fusing the target image and the background image to obtain an augmented reality image based on transparency information of a pixel point in the target image, the above image display method may further include: acquiring a color temperature of the background image; adjusting an image parameter of the target image based on the color temperature and updating the target image according to an adjustment result, wherein the image parameter includes at least one of white balance or brightness. Wherein, in order to ensure that the foreground object and the background object in the AR image obtained after fusion match, the color temperature of the background image may be acquired before the fusion is performed, so that the image parameters such as white balance and/or brightness of the target image are adjusted based on the color temperature, so that the adjusted target image matches the background image in color tone, thereby ensuring the overall consistency of the AR image obtained after subsequent fusion, and the user experience is better.

In order to better understand the above-described embodiments as a whole, they are exemplarily described below in connection with examples. Illustratively, referring to FIG. 4, for each video frame, calibrate the camera used to capture the video frame, and perform spatial conversion of each pixel point in the video frame according to the calibration result, obtaining a calibration image; acquiring a fixed-axis coordinate system, and converting each pixel point in the calibration image into the fixed-axis coordinate system to obtain a fixed-axis image; acquiring an AR coordinate system, and converting each pixel point in the fixed-axis image into the AR coordinate system to obtain a target image; to extend the viewing perspective of the target video, a virtual image in a virtual perspective can be generated based on the target image in the physical perspective and take this virtual image also as the target image; fusing the target image and the background image captured by the camera within the mobile phone, thereby obtaining an AR image; each AR image is sequentially displayed, thereby achieving an AR presentation effect of the target video.

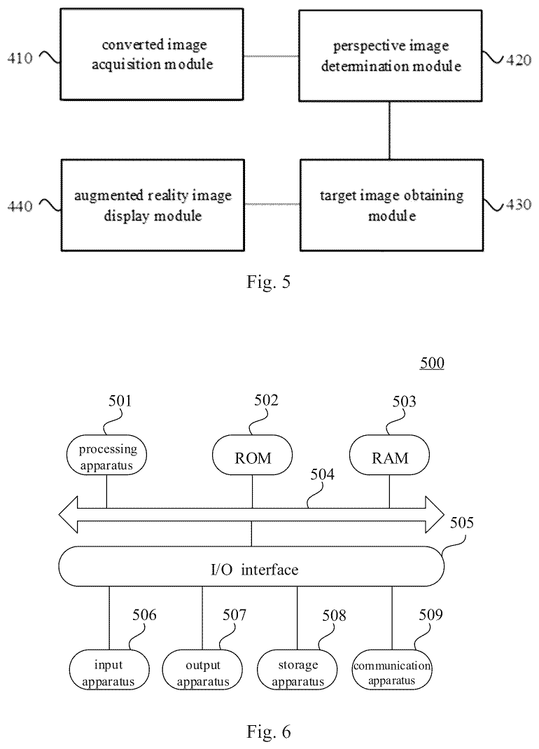

FIG. 5 is a block diagram of a structure of an image display apparatus provided in embodiments of the present disclosure, the apparatus is configured to perform the image display method provided in any of the above embodiments. The apparatus belongs to the same concept as the image display method of the above-described embodiments, and for details not described in detail in the embodiments of the image display apparatus, reference may be made to the above-described embodiments of the image display method. Referring to FIG. 5, the apparatus may include: a converted image acquisition module 410, a perspective image determination module 420, a target image obtaining module 430, and an augmented reality image display module 440.

Wherein the converted image acquisition module 410, configured to acquire a converted image respectively corresponding to each video frame in a target video, wherein the converted image is an image obtained after converting a pixel point located in an image coordinate system in a foreground image into an augmented reality coordinate system, the foreground image is an image including a foreground object and extracted from the video frame, and the target video includes a free perspective video or a light field video;
the perspective image determination module 420, configured to acquire a background pose of a background capturing device at a target moment, and determine a perspective image corresponding to the background pose from at least one converted image corresponding to the target moment;
the target image obtaining module 430, configured to convert a pixel point in the perspective image into a background capturing coordinate system where the background capturing device is located according to the background pose to obtain a target image; and
the augmented reality image display module 440, configured to combine a background image captured by the background capturing device at the target moment with the target image, and display an augmented reality image obtained by the combining.

In an embodiment, on the basis of the above apparatus, the apparatus may further include:
a foreground image extraction module, configured to extract, for each video frame, the foreground image from the video frame;
a calibration result acquisition module, configured to acquire a calibration result of a foreground capturing device used to capture the video frame;
a calibration image acquisition module, configured to convert the pixel point located in an image coordinate system in the foreground image into a foreground capturing coordinate system where the foreground capturing device is located according to the calibration result to obtain a calibration image; and
a converted image obtaining module, configured to convert a pixel point in the calibration image into the augmented reality coordinate system to obtain the converted image.

On this basis, the converted image obtaining module, may include:
a fixed-axis coordinate system acquisition unit, configured to acquire a fixed-axis coordinate system, wherein the fixed-axis coordinate system is a coordinate system determined according to a foreground pose of at least one foreground capturing device or the video frame captured;
a fixed-axis image obtaining unit, configured to convert the pixel point in the calibration image into the fixed-axis coordinate system to obtain a fixed-axis image; and
a converted image obtaining unit, configured to convert a pixel point in the fixed-axis image into the augmented reality coordinate system to obtain the converted image.

On this basis, in an embodiment, the fixed-axis image obtaining unit is configured to:
acquire a first homography matrix from the foreground capturing coordinate system to the fixed-axis coordinate system, and converting the pixel point in the calibration image into the fixed-axis coordinate system based on the first homography matrix to obtain a fixed-axis image.

In an embodiment, the converted image obtaining unit is configured to:
acquire a second homography matrix from the fixed-axis coordinate system to the augmented reality coordinate system, and converting the pixel point in the fixed-axis image into the augmented reality coordinate system based on the second homography matrix to obtain in the converted image.

In an embodiment, the augmented reality image display module 440, may include:
a background image acquisition unit, configured to acquire the background image captured by the background capturing device at the target moment; and
an augmented reality image display unit, configured to fuse the target image and the background image based on transparency information of a pixel point in the target image to obtain an augmented reality image, and display the augmented reality image.

In an embodiment, on the basis of the above device, the device may further include:
a color temperature acquisition module, configured to acquire a color temperature of the background image before the fusing the target image and the background image based on transparency information of a pixel point in the target image;
a target image update module, configured to adjust an image parameter of the target image based on the color temperature and updating the target image according to an adjustment result, wherein the image parameter includes at least one of white balance or brightness.

In an embodiment, the perspective image determination module 420 may include:
a next frame determining unit, configured to take the video frame corresponding to the augmented reality image displayed at a previous moment of the target moment as a previous frame, and determine a next frame of the previous frame from at least one video frame;
a capturing perspective obtaining unit, configured to take the converted image respectively corresponding to each next frame as the converted image corresponding to the target moment, respectively acquiring a capturing perspective of the converted image corresponding to the target moment; and
a perspective image obtaining unit, configured to determine a background perspective corresponding to the background pose from the capturing perspective, and taking the converted image having the background perspective from the at least one converted image corresponding to the target moment as the perspective image.

In an embodiment, the augmented reality image display module 440, may include:
a plane position obtaining unit, configured to acquire the background image captured by the background capturing device at the target moment, identifying a background plane in the background image, and obtaining a plane position of the background plane in the background image;
an image combining unit, configured to combine the background image with the target image based on the plane position so that the foreground object in the augmented reality image obtained by the combining lies on the background plane;
an augmented reality image display unit, configured to display the augmented reality image.

The image display apparatus provided by the embodiment of the present disclosure obtains, using a converted image acquisition module to acquire a converted image respectively corresponding to each video frame in a target video, the converted image may be an image after converting a pixel point located in an image coordinate system in a foreground image extracted from the video frame into an AR coordinate system; acquiring a background pose of the background capturing device at the target moment by the perspective image determining module, and then determining a perspective image corresponding to the background pose from each of the converted images corresponding to the target moment; obtaining a target image by converting pixel points in the perspective image into a background capturing coordinate system where the background capturing device is located according to the background pose by the target-image obtaining module; thus, the background image captured by the background capturing device at the target time is combined with the target image by the augmented reality image display module, and the combined AR image is display. The device described above, can display the video frame in the target video based on the AR manner, i.e., the target video can be played based on the AR manner, which realizes the interactive viewing process of the target video through the AR manner, thereby guaranteeing the degree of freedom when the user watches the target video, and the user experience is better.

The image display apparatus provided by the embodiments of the present disclosure can perform the image display method provided by any of the embodiments of the present disclosure, and has corresponding functional modules and advantageous effects of performing the method.

It is to be noted that in the above embodiment of the image display apparatus, the respective units and modules included are only divided according to the function logic, but are not limited to the above division as long as the corresponding functions can be realized; in addition, the specific names of the respective functional units are also merely for convenience of distinguishing from each other, and are not used to limit the protection scope of the present disclosure.

Referring to FIG. 6 in the below, which shows a schematic structural diagram of an electronic device (e.g., a terminal device or server in FIG. 6) 500 suitable for use in implementing embodiments of the present disclosure. The electronic device in the embodiment of the present disclosure may include, but is not limited to, a mobile terminal such as a mobile phone, a notebook computer, a digital broadcast receiver, a Personal Digital Assistant (PDA), a tablet computer (PAD), a Portable Media Player (PMP), a vehicle-mounted terminal (e.g., a vehicle-mounted navigation terminal), and the like, and a fixed terminal such as a Digital Television (TV), a desktop computer, and the like. The electronic device illustrated in FIG. 6 is merely one example and should not bring any limitation to the scope of functionality and use of embodiments of the present disclosure.

As shown in FIG. 6, the electronic device 500 may include a processing apparatus (e.g., a central processor, a graphics processor, etc.) 501, which may execute various appropriate actions and processes according to a program stored in a read-only memory (ROM) 502 or a program loaded into a random-access memory (RAM) 503 from a storage apparatus 508. In the RAM 503, various programs and data required for the operation of the electronic device 500 are also stored. The processing device 501, the ROM 502 and the RAM 503 are connected to each other by a bus 504. An input/output (I/O) interface 505 is also connected to the bus 504.

Generally, the following devices may be connected to the I/O interface 505; input apparatus 506 including, for example, touch screens, touch pads, keyboards, mice, cameras, microphones, accelerometers, gyroscopes, etc.; an output apparatus 507 including, for example, a liquid crystal display (LCD), a speaker, a vibrator, or the like; storage apparatus 508 including, for example, magnetic tape, hard disk, etc.; and a communication apparatus 509. The communication apparatus 509 may allow the electronic device 500 to engage in wireless or wired communication with other devices to exchange data. While FIG. 6 illustrates electronic device 500 with various means, it should be understood that it is not required that all of the illustrated means be implemented or provided. More or fewer devices may alternatively be implemented or provided.

In particular, according to an embodiment of the present disclosure, the processes described above with reference to the flow charts may be implemented as a computer software program. For example, embodiments of the present disclosure include a computer program product comprising a computer program carried on a non-transitory computer readable medium, the computer program including program code for performing the methods illustrated by the flow charts. In such an embodiment, the computer program may be downloaded and installed from the network via the communication device 509, or installed from the storage device 508, or installed from the ROM 502. When this computer program is executed by the processing device 501, the above-described functions defined in the methods of the embodiments of the present disclosure are performed.

It should be noted that the computer-readable medium described above in this disclosure may be a computer-readable signal medium or a computer-readable storage medium or any combination of both. The computer readable storage medium may be, for example, but not limited to, an electronic, magnetic, optical, electromagnetic, infrared, or semiconductor system, apparatus, or device, or any combination of the foregoing. More specific examples of a computer readable storage medium may include, but are not limited to, an electrical connection having one or more wires, a portable computer diskette, a hard disk, a random-access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the present disclosure, a computer readable storage medium may be any tangible medium that contains, or stores a program for use by or in connection with an instruction execution system, apparatus, or device. In the present disclosure, a computer readable signal medium may include a propagated data signal with computer readable program code embodied therein, either in baseband or as part of a carrier wave. Such a propagated data signal may take many forms, including, but not limited to, an electromagnetic signal, an optical signal, or any suitable combination of the foregoing. A computer readable signal medium may also be any computer readable medium that is not a computer readable storage medium that can communicate, propagate, or transport a program for use by or in connection with an instruction execution system, apparatus, or device. Program code embodied on a computer readable medium may be transmitted using any appropriate medium, including but not limited to electrical wiring, optical fiber cable, RF (radio frequency), etc., or any suitable combination of the foregoing.

In some implementation, the clients, servers may communicate using any currently known or future developed network protocol, such as HTTP, and may be interconnected with any form or medium of digital data communication (e.g., a communication network). Examples of communication networks include a local area network (“Local Area Network, LAN”), a wide area network (“Wide Area Network, WAN”), an internetwork (e.g., the Internet), and end-to-end networks (e.g., ad hoc end-to-end networks), as well as any currently known or future developed network.

The above-mentioned computer-readable medium may be included in the above-mentioned electronic device; it may also be present separately and not incorporated into the electronic device.

The computer-readable medium carrying one or more programs that, when executed by the electronic device, cause the electronic device to:
acquiring a converted image respectively corresponding to each video frame in a target video, wherein the converted image is an image obtained after converting a pixel point located in an image coordinate system in a foreground image into an augmented reality coordinate system, the foreground image is an image including a foreground object extracted from the video frame, and the target video includes a free perspective video or a light field video;
acquiring a background pose of a background capturing device at a target moment, and determining a perspective image corresponding to the background pose from each converted image corresponding to the target moment;
converting a pixel point in the perspective image into a background capturing coordinate system where the background capturing device is located according to the background pose, obtaining a target image; and
combining a background image captured by the background capturing device at the target moment with the target image, and displaying a combined augmented reality image.

The storage medium may be a non-transitory storage medium.

Computer program code for carrying out operations of the present disclosure may be written in one or more programming languages or combinations thereof, including without limitation an object-oriented programming language such as Java, Smalltalk. C++ and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the scenario involving a remote computer, the remote computer may be connected to the user's computer through any type of network, including a local area network (LAN) or a wide area network (WAN), or the connection may be made to an external computer (for example, through the Internet using an Internet Service Provider).

The flowchart and block diagrams in the Figures illustrate the architecture, functionality, and operation of possible implementations of systems, methods, and computer program products according to various embodiments of the present disclosure. In this regard, each block in the flowchart or block diagrams may represent a module, segment, or portion of code, which includes one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or operations or combinations of special purpose hardware and computer instructions.

The units described in the embodiments of the present disclosure may be implemented by means of software or by means of hardware. Wherein the name of a unit does not constitute a definition of the unit itself in some cases, for example, the converted image acquisition module may be further described as “a module for acquiring a converted image respectively corresponding to each video frame in a target video, wherein the converted image is an image obtained after converting a pixel point located in an image coordinate system in a foreground image into an augmented reality coordinate system, the foreground image is an image including a foreground object extracted from the video frame, and the target video includes a free perspective video or a light field video”.

The functionality described above herein can be performed, at least in part, by one or more hardware logic components. For example, and without limitation, illustrative types of hardware logic components that can be used include Field-programmable Gate Arrays (FPGA), Application-specific Integrated Circuits (ASIC), Application-specific Standard Products (ASSP), System-on-a-chip systems (SOC). Complex Programmable Logic Devices (CPLD), etc.

In the context of the present disclosure, a machine-readable medium may be a tangible medium that can contain, or store a program for use by or in connection with an instruction execution system, apparatus, or device. The machine readable medium may be a machine readable signal medium or a machine readable storage medium. A machine readable medium may include, but is not limited to, an electronic, magnetic, optical, electromagnetic, infrared, or semiconductor system, apparatus, or device, or any suitable combination of the foregoing. Examples of the machine readable storage medium would include an electrical connection based on one or more wires, a portable computer diskette, a hard disk, a random access memory (RAM), a read-only memory (ROM), an erasable programmable read-only memory (EPROM) or Flash memory, an optical fiber, a convenient compact disc read-only memory (CD-ROM), an optical storage device, a magnetic storage device, or any suitable combination of the foregoing.

According to one or more embodiments of the present disclosure, [Example One] provides an image display method, the method may include:
acquiring a converted image respectively corresponding to each video frame in a target video, wherein the converted image is an image obtained after converting a pixel point located in an image coordinate system in a foreground image into an augmented reality coordinate system, the foreground image is an image including a foreground object extracted from the video frame, and the target video includes a free perspective video or a light field video;
acquiring a background pose of a background capturing device at a target moment, and determining a perspective image corresponding to the background pose from each converted image corresponding to the target moment;
converting a pixel point in the perspective image into a background capturing coordinate system where the background capturing device is located according to the background pose, obtaining a target image; and
combining a background image captured by the background capturing device at the target moment with the target image, and displaying a combined augmented reality image.

According to one or more embodiments of the present disclosure, [Example Two] provides the method of Example One, the above image method, may further include:
extracting, for each of the video frames, the foreground image from the video frame;
acquiring a calibration result of a foreground capturing device used to capture the video frame;
converting the pixel point located in an image coordinate system in the foreground image into a foreground capturing coordinate system where the foreground capturing device is located according to the calibration result, obtaining a calibration image; and
converting a pixel point in the calibration image into the augmented reality coordinate system, obtaining the converted image.

In accordance with one or more embodiments of the present disclosure, [Example Three] provides the method of Example Two, converting a pixel point in the calibration image into the augmented reality coordinate system, obtaining the converted image may include:
acquiring a fixed-axis coordinate system, wherein the fixed-axis coordinate system is a coordinate system determined according to a foreground pose of each foreground capturing device or the video frame captured;
converting the pixel point in the calibration image into the fixed-axis coordinate system, obtaining a fixed-axis image; and
converting a pixel point in the fixed-axis image into the augmented reality coordinate system, obtaining the converted image.

According to one or more embodiments of the present disclosure, [Example Four] provides the method of Example Three, wherein converting the pixel points in the calibration image into an on-axis coordinate system resulting in an on-axis image may include:
acquiring a first homography matrix from the foreground capturing coordinate system to the fixed-axis coordinate system, and converting the pixel point in the calibration image into the fixed-axis coordinate system based on the first homography matrix, obtaining a fixed-axis image.

According to one or more embodiments of the present disclosure, [Example 5] provides the method of Example 3, wherein converting a pixel point in the fixed-axis image into the augmented reality coordinate system, obtaining the converted image may include:
acquiring a second homography matrix from the fixed-axis coordinate system to the augmented reality coordinate system, and converting a pixel point in the fixed-axis image into the augmented reality coordinate system based on the second homography matrix, obtaining in the converted image.

According to one or more embodiments of the present disclosure, [Example 6] provides the method of Example 1, combining a background image captured by the background capturing device at the target moment with the target image, and displaying a combined augmented reality image, may include:
acquiring a background image captured by the background capturing device at the target moment;
fusing the target image and the background image to obtain an augmented reality image based on transparency information of each pixel point in the target image, and displaying the augmented reality image.

According to one or more embodiments of the present disclosure, [Example 7] provides the method of Example 6, fusing the target image and the background image to obtain an augmented reality image based on transparency information of each pixel point in the target image, the image display method may further include:
acquiring a color temperature of the background image;
adjusting an image parameter of the target image based on the color temperature and updating the target image according to an adjustment result, wherein the image parameter includes at least one of white balance or brightness.

According to one or more embodiments of the present disclosure. [Example 8] provides the method of Example 1, wherein the determining a perspective image corresponding to the background pose from each converted image corresponding to the target moment, may include:
taking the video frame corresponding to the augmented reality image displayed at a previous moment of the target moment as a previous frame, and determining a next frame of the previous frame from each video frame;
taking the converted image respectively corresponding to each next frame as the converted image corresponding to the target moment, respectively acquiring a capturing perspective of each converted image corresponding to the target moment;
determining a background perspective corresponding to the background pose from the capturing perspective, and taking the converted image having the background perspective from at each converted image corresponding to the target moment as a perspective image.

According to one or more embodiments of the present disclosure, there is provided the method of Example One, wherein the combining a background image captured by the background capturing device at the target moment with the target image, and displaying a combined augmented reality image, may include:
acquiring a background image captured by the background capturing device at the target moment, identifying a background plane in the background image, and obtaining a plane position of the background plane in the background image;
combining the background image with the target image based on the plane position so that the foreground object in the combined augmented reality image lies on the background plane;
displaying the augmented reality image.

According to one or more embodiments of the present disclosure, [Example Ten] provides an image display apparatus, the apparatus may include:
a converted image acquisition module, configured to acquire a converted image respectively corresponding to each video frame in a target video, wherein the converted image is an image obtained after converting a pixel point located in an image coordinate system in a foreground image into an augmented reality coordinate system, the foreground image is an image including a foreground object extracted from the video frame, and the target video includes a free perspective video or a light field video;
a perspective image determination module, configured to acquire a background pose of a background capturing device at a target moment, and determine a perspective image corresponding to the background pose from each converted image corresponding to the target moment;
a target image obtaining module, configured to convert a pixel point in the perspective image into a background capturing coordinate system where the background capturing device is located according to the background pose, obtain a target image; and
an augmented reality image display module, configured to combine a background image captured by the background capturing device at the target moment with the target image, and display a combined augmented reality image.

Those skilled in the art should understand that the disclosure scope involved in the present disclosure is not limited to embodiments composed of specific combinations of the above technical features, but should also cover embodiments composed of the above technical features or without departing from the above disclosed concept. Other embodiments may be formed by any combination of equivalent features. For example, embodiments are formed by replacing the above features with technical features disclosed in this disclosure (but not limited to) with similar functions.

Furthermore, although operations are depicted in a specific order, this should not be understood as requiring that these operations be performed in the specific order shown or performed in a sequential order. Under certain circumstances, multitasking and parallel processing may be advantageous. Likewise, although several specific implementation details are included in the above discussion, these should not be construed as limiting the scope of the present disclosure. Certain features that are described in the context of separate embodiments can also be implemented in combination in a single embodiment. Conversely, various features that are described in the context of a single embodiment can also be implemented in multiple embodiments separately or in any suitable sub combination.

Although the subject matter has been described in language specific to structural features and/or methodological acts, it is to be understood that the subject matter defined in the appended claims is not necessarily limited to the specific features or acts described above. Rather, the specific features and acts described above are merely example forms of implementing the claims.

1. An image display method, comprising:
acquiring a converted image corresponding to each video frame in a target video, wherein the converted image is an image obtained after converting a pixel point located in an image coordinate system in a foreground image into an augmented reality coordinate system, the foreground image is an image comprising a foreground object and extracted from the video frame, and the target video comprises a free perspective video or a light field video;
acquiring a background pose of a background capturing device at a target moment, and determining a perspective image corresponding to the background pose from at least one converted image corresponding to the target moment;
converting a pixel point in the perspective image into a background capturing coordinate system where the background capturing device is located according to the background pose to obtain a target image; and
combining a background image captured by the background capturing device at the target moment with the target image to obtain an augmented reality image, and displaying the augmented reality image.

2. The method according to claim 1, further comprising:
extracting, for each video frame, the foreground image from the video frame;
acquiring a calibration result of a foreground capturing device used to capture the video frame;
converting the pixel point located in the image coordinate system in the foreground image into a foreground capturing coordinate system where the foreground capturing device is located according to the calibration result to obtain a calibration image; and
converting a pixel point in the calibration image into the augmented reality coordinate system to obtain the converted image.

3. The method according to claim 2, wherein the converting a pixel point in the calibration image into the augmented reality coordinate system to obtain the converted image comprises:
acquiring a fixed-axis coordinate system, wherein the fixed-axis coordinate system is a coordinate system determined according to a foreground pose of at least one foreground capturing device or the video frame captured;
converting the pixel point in the calibration image into the fixed-axis coordinate system to obtain a fixed-axis image; and
converting a pixel point in the fixed-axis image into the augmented reality coordinate system to obtain the converted image.

4. The method according to claim 3, wherein the converting the pixel point in the calibration image into the fixed-axis coordinate system to obtain a fixed-axis image comprises:
acquiring a first homography matrix from the foreground capturing coordinate system to the fixed-axis coordinate system, and converting the pixel point in the calibration image into the fixed-axis coordinate system based on the first homography matrix to obtain the fixed-axis image.

5. The method according to claim 3, wherein the converting a pixel point in the fixed-axis image into the augmented reality coordinate system to obtain the converted image comprises:
acquiring a second homography matrix from the fixed-axis coordinate system to the augmented reality coordinate system, and converting the pixel point in the fixed-axis image into the augmented reality coordinate system based on the second homography matrix to obtain the converted image.

6. The method according to claim 1, wherein the combining a background image captured by the background capturing device at the target moment with the target image to obtain an augmented reality image, and displaying the augmented reality image comprises:
acquiring the background image captured by the background capturing device at the target moment;
fusing the target image and the background image based on transparency information of a pixel point in the target image to obtain the augmented reality image, and displaying the augmented reality image.

7. The method according to claim 6, before the fusing the target image and the background image based on transparency information of a pixel point in the target image, further comprising:
acquiring a color temperature of the background image;
adjusting an image parameter of the target image based on the color temperature and updating the target image according to an adjustment result, wherein the image parameter comprises at least one of white balance or brightness.

8. The method according to claim 1, wherein the determining a perspective image corresponding to the background pose from at least one converted image corresponding to the target moment comprises:
taking a video frame corresponding to an augmented reality image displayed at a previous moment of the target moment as a previous frame, and determining at least one next frame of the previous frame from at least one video frame;
taking at least one converted image respectively corresponding to at least one next frame as the at least one converted image corresponding to the target moment, respectively acquiring at least one capturing perspective of the at least one converted image corresponding to the target moment;
determining a background perspective corresponding to the background pose from the at least one capturing perspective, and taking the converted image having the background perspective from the at least one converted image corresponding to the target moment as the perspective image.

9. The method according to claim 1, wherein combining a background image captured by the background capturing device at the target moment with the target image to obtain an augmented reality image, and displaying the augmented reality image comprises:
acquiring the background image captured by the background capturing device at the target moment, identifying a background plane in the background image, and obtaining a plane position of the background plane in the background image;
combining the background image with the target image based on the plane position so that the foreground object in the augmented reality image lies on the background plane;
displaying the augmented reality image.

10. (canceled)

11. An electronic device, comprising:
one or more processors;
a memory, configured to store one or more programs;
wherein when the one or more programs are executed by the one or more processors, cause the one or more processors to implement an image display method, which comprises:
acquiring a converted image corresponding to each video frame in a target video, wherein the converted image is an image obtained after converting a pixel point located in an image coordinate system in a foreground image into an augmented reality coordinate system, the foreground image is an image comprising a foreground object and extracted from the video frame, and the target video comprises a free perspective video or a light field video;
acquiring a background pose of a background capturing device at a target moment, and determining a perspective image corresponding to the background pose from at least one converted image corresponding to the target moment;
converting a pixel point in the perspective image into a background capturing coordinate system where the background capturing device is located according to the background pose to obtain a target image; and
combining a background image captured by the background capturing device at the target moment with the target image to obtain an augmented reality image, and displaying the augmented reality image.

12. A non-transitory computer-readable storage medium, wherein computer programs are stored on the non-transitory computer-readable storage medium, when the computer programs are executed by a processor, an image display method is implemented, and the method comprises:
acquiring a converted image corresponding to each video frame in a target video, wherein the converted image is an image obtained after converting a pixel point located in an image coordinate system in a foreground image into an augmented reality coordinate system, the foreground image is an image comprising a foreground object and extracted from the video frame, and the target video comprises a free perspective video or a light field video;
acquiring a background pose of a background capturing device at a target moment, and determining a perspective image corresponding to the background pose from at least one converted image corresponding to the target moment;
converting a pixel point in the perspective image into a background capturing coordinate system where the background capturing device is located according to the background pose to obtain a target image; and
combining a background image captured by the background capturing device at the target moment with the target image to obtain an augmented reality image, and displaying the augmented reality image.

13. The electronic device according to claim 11, wherein the image display method further comprises:
extracting, for each video frame, the foreground image from the video frame;
acquiring a calibration result of a foreground capturing device used to capture the video frame;
converting the pixel point located in the image coordinate system in the foreground image into a foreground capturing coordinate system where the foreground capturing device is located according to the calibration result to obtain a calibration image; and
converting a pixel point in the calibration image into the augmented reality coordinate system to obtain the converted image.

14. The electronic device according to claim 13, wherein the converting a pixel point in the calibration image into the augmented reality coordinate system to obtain the converted image comprises:
acquiring a fixed-axis coordinate system, wherein the fixed-axis coordinate system is a coordinate system determined according to a foreground pose of at least one foreground capturing device or the video frame captured;
converting the pixel point in the calibration image into the fixed-axis coordinate system to obtain a fixed-axis image; and
converting a pixel point in the fixed-axis image into the augmented reality coordinate system to obtain the converted image.

15. The electronic device according to claim 14, wherein the converting the pixel point in the calibration image into the fixed-axis coordinate system to obtain a fixed-axis image comprises:
acquiring a first homography matrix from the foreground capturing coordinate system to the fixed-axis coordinate system, and converting the pixel point in the calibration image into the fixed-axis coordinate system based on the first homography matrix to obtain the fixed-axis image.

16. The electronic device according to claim 14, wherein the converting a pixel point in the fixed-axis image into the augmented reality coordinate system to obtain the converted image comprises:
acquiring a second homography matrix from the fixed-axis coordinate system to the augmented reality coordinate system, and converting the pixel point in the fixed-axis image into the augmented reality coordinate system based on the second homography matrix to obtain the converted image.

17. The electronic device according to claim 11, wherein the combining a background image captured by the background capturing device at the target moment with the target image to obtain an augmented reality image, and displaying the augmented reality image comprises:
acquiring the background image captured by the background capturing device at the target moment;
fusing the target image and the background image based on transparency information of a pixel point in the target image to obtain the augmented reality image, and displaying the augmented reality image.

18. The electronic device according to claim 17, wherein before the fusing the target image and the background image based on transparency information of a pixel point in the target image, the method further comprises:
acquiring a color temperature of the background image;
adjusting an image parameter of the target image based on the color temperature and updating the target image according to an adjustment result, wherein the image parameter comprises at least one of white balance or brightness.

19. The electronic device according to claim 11, wherein the determining a perspective image corresponding to the background pose from at least one converted image corresponding to the target moment comprises:
taking a video frame corresponding to an augmented reality image displayed at a previous moment of the target moment as a previous frame, and determining at least one next frame of the previous frame from at least one video frame;
taking at least one converted image respectively corresponding to at least one next frame as the at least one converted image corresponding to the target moment, respectively acquiring at least one capturing perspective of the at least one converted image corresponding to the target moment;
determining a background perspective corresponding to the background pose from the at least one capturing perspective, and taking the converted image having the background perspective from the at least one converted image corresponding to the target moment as the perspective image.

20. The electronic device according to claim 11, wherein combining a background image captured by the background capturing device at the target moment with the target image to obtain an augmented reality image, and displaying the augmented reality image comprises comprises:
acquiring the background image captured by the background capturing device at the target moment, identifying a background plane in the background image, and obtaining a plane position of the background plane in the background image;
combining the background image with the target image based on the plane position so that the foreground object in the augmented reality image lies on the background plane;
displaying the augmented reality image.

21. The non-transitory computer-readable storage medium according to claim 12, wherein the image display method further comprises:
extracting, for each video frame, the foreground image from the video frame;
acquiring a calibration result of a foreground capturing device used to capture the video frame;
converting the pixel point located in the image coordinate system in the foreground image into a foreground capturing coordinate system where the foreground capturing device is located according to the calibration result to obtain a calibration image; and
converting a pixel point in the calibration image into the augmented reality coordinate system to obtain the converted image.
